(19) United States
(12) Patent Application Publication
(10) Pub. No.: US 2005/0099530 A1
(43) Pub. Date: May 12, 2005

(54) Image pickup device

(76) Inventor: Koji Mizobuchi, Sagamihara-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 10/980,969

(22) Filed: Nov. 4, 2004

(30) Foreign Application Priority Data
Nov. 12, 2003 (JP) 2003-382872

(51) Int. Cl. H04N 5/222

(52) U.S. Cl. 348/370

(57) ABSTRACT

In an image pickup device of the present invention, at a time of an image capture, electric power is supplied by a voltage boosting section in a light emitting section to allow a speaker to be illuminated by an illuminating section. In a switch operation section and control section, control is made such that, if only a predetermined operation switch is operated, power is supplied to the voltage boosting section to start a voltage boosting operation. An image signal of the speaker picked up by the image pickup section of an image pickup device is converted to a digital signal and, after being encoded by an encoding section, is stored in a predetermined area of a storage section in a form related to a voice signal of the speaker.

### CROSS-REFERENCE TO RELATED APPLICATIONS

This application is based upon and claims the benefit of priority from prior Japanese Patent Application No. 2003-382872, filed Nov. 12, 2003, the entire contents of which are incorporated herein by reference.

### BACKGROUND OF THE INVENTION

1. Field of the Invention

The present invention relates to an image pickup device and, more particularly, to a data processing apparatus, such as a voice recording/reproducing apparatus, equipped with an image pickup function.

2. Description of the Related Art

As well known in the art, portable voice recording/reproducing apparatuses (here called an IC recorder) have steadily gained popularity since around the latter half of the 1990's. The IC recorder is of such a type as to, after converting a voice signal to digital data, store it in a flash memory rewritable recording medium and, after converting the voice data which has been recorded in the flash memory to an analog form, reproduce it. In recent years, an IC recorder equipped with an image pickup function has also been put into practice, and this recorder, while recording voice, can also record an image.

Incidentally, upon image pickup under a lower illuminance, it is necessary to provide a light source for illumination. In the case of an electronic still camera in particular, a main subject is illuminated only during an exposure time with the use of a strobe light. In this connection, a proposal has been made in which, by varying the light emittance, both the still image and moving image can be captured with the use of one shared strobe light. That is, JPN PAT APPLN KOKAI PUBLICATION NO. 2001-76891 has disclosed the technique by which, with the use of one shared strobe light for capture of a still image and video light upon the capture of a moving image, a single shot is taken under a higher illuminance at a time of capturing a still image and continuous light is emitted under a lower illuminance at a time of capturing a moving image. The high/low illuminance is obtained by the switching of the capacitances of main capacitors and controlling the high/low level of a charging voltage.

It may be considered that, when voice recording is mainly intended, the subjects to be picked up are in the near distance. In the case of an interview, for example, a main subject is considered to be an interviewee. In the case of written contents on a book or whiteboard, a main subject is considered to be characters (image).

Further, most subjects at a time of picking up an image may be considered to be motionless. As an illumination light source, therefore, a light emission amount may be adequate for at least a still image to be picked up at proper light exposure under a lower illuminance in a near distance.

In the strobe light for an electronic still camera disclosed in the KOKAI PUBLICATION NO. 2001-76891, use is made of two main capacitors of different electro-static capacities so as to pickup both a static image and a moving image.

### BRIEF SUMMARY OF THE INVENTION

It is accordingly the object of the present invention to provide an easy-to-handle image pickup device of lower power consumption which can easily recognize a speaker and his or her massages at a time of reproduction.

In one aspect of the present invention, there is provided an image pickup device comprising a light emitting element configured to illuminate a subject; a voltage boosting circuit configured to boost a power supply voltage up to a voltage value necessary for the light emitting element to emit light and to supply electric power to the light emitting element; light emitting control means configured to control the light emission of the light emitting element by controlling the electric power supplied from the voltage boosting circuit to the light emitting element; and voltage boosting control means configured to, in response to the operation of a predetermined operation switch, start the boosting of the power supply voltage by the voltage boosting circuit.

In another aspect of the present invention, there is provided an image pickup device comprising image pickup means configured to pick up image data of a subject during the recording of voice data; storage means configured to store the voice data and the image data related to the voice data; a light emitting element configured to illuminate the subject; a voltage boosting circuit configured to boost a power supply voltage up to a voltage value necessary for the light emission of the light emitting element and supply electric power to the light emitting element; light emitting control means configured to control the light emission of the light emitting element by controlling the electric power supplied from the voltage boosting circuit to the light emitting element; and voltage control means configured to, in response to the operation of a predetermined operation switch, start the boosting of the power supply voltage by the voltage boosting circuit.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a schematic arrangement of a data processing apparatus according to a first embodiment of the present invention;

FIG. 2 is a block diagram showing an arrangement of an IC recorder according to the first embodiment of the present invention;

FIG. 3 is a flowchart for explaining a main operation of the IC recorder according to the first embodiment of the present invention;

FIG. 4 is a flowchart for explaining the operation of a subroutine “record processing” at step S10 in the flowchart shown in FIG. 3;

FIG. 5 is a view showing a relation between a voice data area and an index information area;

FIG. 6 is a flowchart for explaining the operation of a subroutine “image capturing processing” at step S32 in the flowchart shown in FIG. 4;

FIG. 7 is a flowchart for explaining the operation of a subroutine “reproduction processing” at step S11 in a flowchart shown in FIG. 3;

FIG. 8 is a flowchart for explaining the operation of a subroutine “image reproduction processing” at step S62 in a flowchart of FIG. 7;

FIGS. 9A and 9B show the outer appearances of the IC recorder according to the first embodiment of the present invention, FIG. 9A being a top view and FIG. 9B being a front view showing the state of an operation display section at a time of recording;

FIGS. 10A and 10B are views for explaining the states of recording and voice/image reproduction of a speaker with the use of the IC recorder shown in FIGS. 9A and 9B, FIG. 10A being an explanatory view for explaining the recording operation of an IC recorder 80 and FIG. 10B being a view showing the state of a voice/image reproduction of the IC recorder 80;

FIG. 11 is a flowchart for explaining a main operation of an IC recorder according to a second embodiment of the present invention;

FIG. 12 is a flowchart for explaining the operation of a subroutine “release processing” at a step S108 in the flowchart of FIG. 11;

FIGS. 13A to 13C are views showing a schematic arrangement of a voltage boosting and light emitting operation circuit in the second embodiment of the present invention; and

FIG. 14 is a timing chart for explaining the operation of the light emitting timing of the second embodiment.

### DETAILED DESCRIPTION OF THE INVENTION

The embodiments of the present invention will be explained below with reference to the drawing.

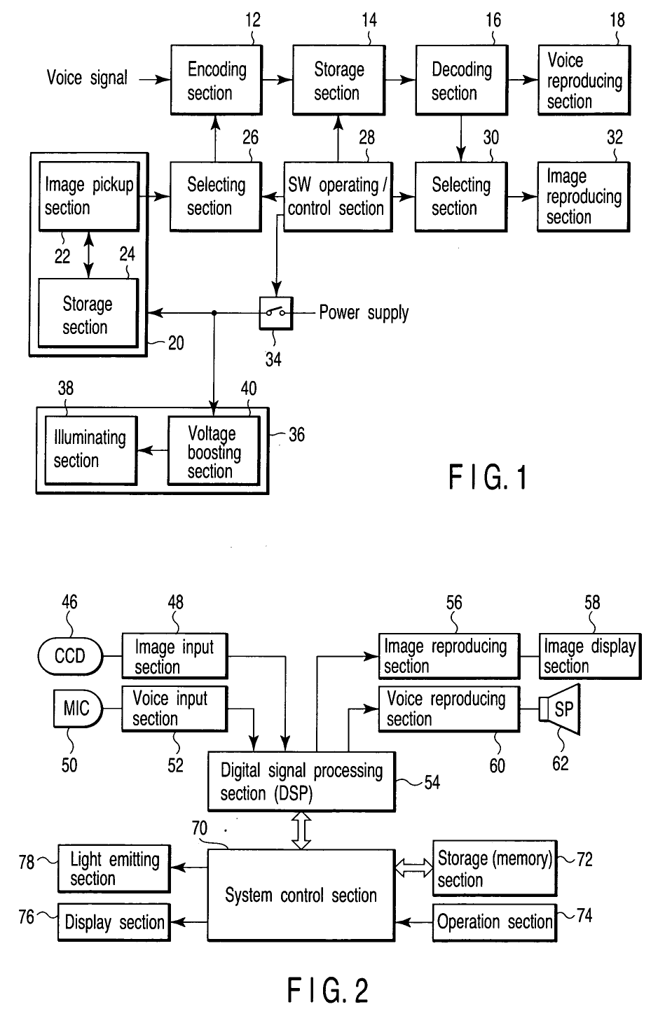

FIG. 1 is a block diagram showing a schematic arrangement of a data processing apparatus according to the first embodiment of the present invention.

As shown in FIG. 1, the data processing apparatus of the present embodiment comprises an encoding section 12 for encoding a voice signal and image signal, a storage section 14, a decoding section 16 for decoding the encoded signal, a voice reproducing section 18, an image pickup device 20 having an image pickup section 22 and storage section 24, an SW operating/control section 28, selecting sections 26 and 30, an image reproduction section 32, a switching section 34 and a light emitting section 36 having an illuminating section 38 and voltage boosting section 40.

The encoding section 12 is provided for encoding the voice signal and image signal to voice data and image data of a predetermined format. The storage section 14 is provided for storing the voice data and image data related to the voice data. The decoding section 16 is provided for decoding the voice data and image data which are read out from the storage section 14 at a time of reproduction to a voice signal and image signal in accordance with a predetermined decoding format. The voice reproducing section 18 reproduces the decoded voice as voice.

The image pickup section 22 in the image pickup device 20 is used to acquire an image of a subject and the storage section 14 is used to enable the image data which is output from the image pickup section 22 to be temporarily stored at least in at one-frame units.

The selecting section 26 selects image data of the image pickup device 20 and inputs it to the encoding section 12. The switch operating/control section 28 comprises a switching operation section having a plurality of operation switches and a control section performing a predetermined sequence in accordance with an input state of the operation switch and functioning as a light emitting control means and a voltage control means.

The specific switch of the switch operation section and control section 28 is comprised of a two-step pressing switch button having a first release switch and a second release switch. The first release switch is closed by pressing the release button to its first-step level and a second release switch is closed by pressing the release button to its second-step level.

The selecting section 30 is used to selectively output only the image signal which is related to the voice signal to the image reproducing section 32. The image reproducing section 32 reproduces a decoded image signal, at a time of recording only, as an image by operating the specific switch of the switch operation/control section 28.

The switching section 34 is of such a type that, when the specific switch of the switch operation/control section 28 is operated, the switching section supplies electric power to the image pickup device 20 and light emitting section 36 only during the predetermined image processing and exposure control periods.

The illuminating section 38 in the light emitting section 36 is comprised of a light emitting element which illuminates the subject upon picking up an image mainly under a lower illumination. The voltage boosting section 40 is comprised of a voltage boosting circuit for driving the illuminating section 38 by a predetermined voltage pulse.

In the thus structured data processing apparatus, when the first release switch of the switching operating/control section 28 is closed, electric power is supplied by the switching section 34 to the image pickup device 20 and light emitting section 36 and, upon a closure of the second release switch, an image pickup operation is started.

When an image of a subject is acquired by the image pickup section 22 in the image pickup device 20, corresponding image data output from the image pickup section 22 is temporarily stored in the storage section 24 at least in one-frame units. At the recording time, the image data of the image pickup device 20 is selected by the selecting section 26 by operating the specified switch of the switch operating/control section 28 and is input to the encoding section 12. In the encoding section 12, the voice signal and image signal are encoded as voice data and image data in a predetermined format. The encoded voice data and image data related to the voice data are stored in the storage section 14.

When an image is acquired under a low illumination, a power supply voltage which is obtained through the switching section 34 is boosted by the boosting section 40 to a pulse of a predetermined voltage and a corresponding subject is illuminated by strobe light from the illuminating section 38.

At the time of reproduction, the voice data and image data read out from the storage section 14 are decoded by the decoding section 16 as a voice signal and image signal in accordance with a predetermined decoding format. The decoded voice signal is reproduced by the voice reproducing section 18 as voice. Further, the image signal only related to the voice signal is output to the image reproducing section 32 by being selected at the selecting section 30. At the image reproducing section 32 the decoded image signal is reproduced as an image.

It is to be noted that the power supply to the image pickup device 20 and light emitting section 36 is stopped simultaneously with the predetermined image processing and exposure control and the opening of the first release switch or the opening of the second release switch.

FIG. 2 shows a block diagram showing the structure of an IC recorder of an image pickup device according to the first embodiment of the present invention.

In FIG. 2, the IC recorder of the present embodiment is so constructed as to have the image pickup device (CCD) 46 for converting an image to an electric signal, an image input section 48, a microphone (MIC) 50 for converting voice to an electric signal, and a voice input section 52.

The image input section 48 comprises respective control circuits for an iris, gain, white balance, etc., and A/D converter, not shown. The image input section 48 allows image data to be input from the image pickup device (CCD) 46 and also functions as exposure light amount detecting means. Each pixel signal which is output from the image pickup element (CCD) 46 is converted by the image input section 48 to a digital signal.

Similarly, the voice input section 52 comprises a microphone amplifier, lowpass filter and A/D converter, not shown. The voice input section 52 allows voice to be input from the microphone (MIC) 50. The analog voice signal amplified by the microphone amplifier is converted by the A/D converter to a digital signal after any spurious frequency band has been cut by the lowpass filter.

The respective digital signals of the image and voice are input to the digital signal processing section (DSP) 54. The digital signal processing section (DSP) 54 is controlled by the system control section 66 at a time of recording to allow the respective digital signal to be encoded (compressed) to voice and image data of a predetermined encoding format in frame units. The respective encoded data are temporarily stored in a buffer memory, not shown, in a system control section 70.

The digital signal processing section (DPS) 54 at the time of reproduction is controlled by the system control section 70 to allow the voice and image data from the buffer memory, not shown, in the system control section 70 to be decoded (expanded) in frame units.

The digital signal of the encoded image is input to an image reproducing section 56. The image reproducing section 56 comprises a video control circuit and D/A converter, not shown. The image signal which is converted by the image reproducing section 56 to an analog signal is displayed as an image on an image display section 58 such as a TFT-LCD.

Similarly, the digital signal of the encoded voice is input to a voice reproducing section 60. The voice reproducing section 60 comprises a D/A converter, a lowpass filter and power amplifier, not shown. The voice signal converted by the D/A converter to the analog signal, after any spurious frequency band has been removed, is amplified by the power amplifier and output as a voice from the speaker (SP) 62.

The system control section 70 is comprised of a CPU. The system control section 70 is connected not only to the digital signal processing section 54 but also to a storage (memory) section 72, an operation section 74, a display section 76 and a light emitting section 78.

The storage (memory) section 72 is comprised of a nonvolatile semiconductor memory, such as a flash memory. At a time of recording, the voice and image data encoded by the digital signal processing section 54 are stored in the memory section through a buffer memory, not shown, in the system control section 70. At this time, index information related to the voice and image data is also stored there.

The operating section 74 has, though not shown, various kinds of switches arranged by function, such as a recording switch (REC), reproducing (playback) switch (PLAY), stop switch (STOP), fast forward switch (FF), REW switch, menu switch (MENU) and hold switch (HOLD).

The display section 76 displays an operation mode when a predetermined sequence is started by the operation of any switch on the operation section 74 or its subsequent operation state. When, for example, the recording switch (REC) is depressed, the display section displays an elapsed time of recording, a remaining recordable time, a file number, and so on. When the menu switch (MENU) is depressed, the display section makes a function-select-related display, such as a MIC sensitivity (high/low), recording mode (standard/long) and alarm (ON/OFF).

Further, when the system control section 70 has a clock function, it also displays a present time of day. The display contents may be displayed on the image display section 58.

The light emitting section 78 emits light when the luminance of a subject fails to satisfy a given exposure light sensitivity level of the image pickup element (CCD) upon taking an image of the subject under a lower illuminance in a room, etc. Since, as set out above, the light emitting voltage is boosted by depressing the release button to its first-step level and the taking of an image (light emission at a lower illuminance level) is done by depressing that release button to its second-step level, use can be made of a controllable white color LED, etc., having a light emitting tube lower in voltage but higher in response. Where at least a near-distant subject is illuminated, an adequate illumination can be obtained even under a white-color LED.

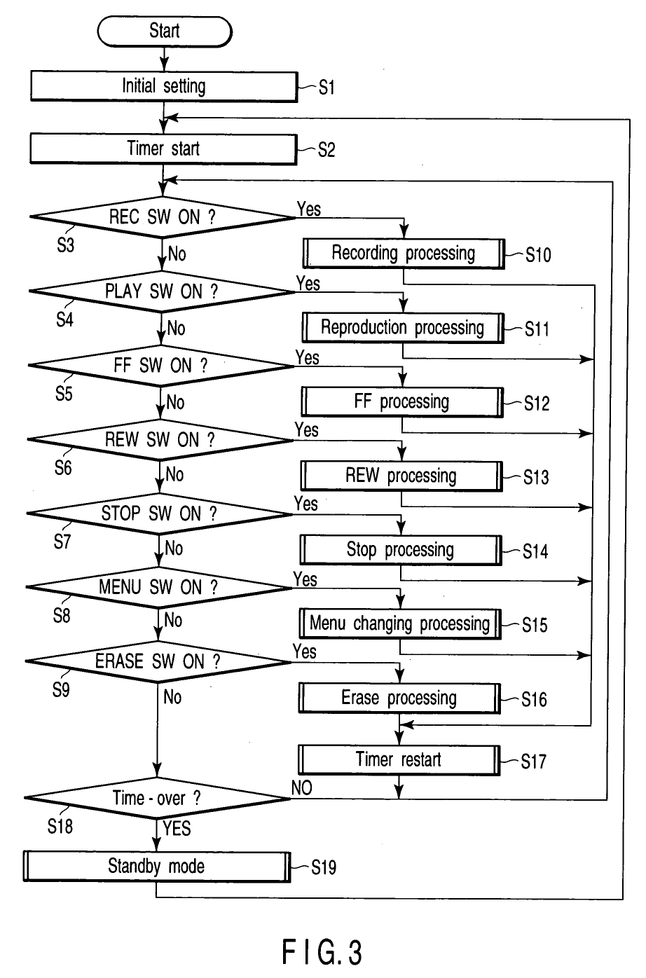

The operation of the IC recorder of the first embodiment will be explained below with reference to the flowchart of FIG. 3.

FIG. 3 is a flowchart for explaining the main operation of the IC recorder according to the first embodiment of the present invention.

When the IC recorder is turned ON by the operation of a switch, not shown, a predetermined initializing step is performed by the system control section 70. Then a timer is started at step S2. This timer is configured to count a time for the IC recorder to enter a standby mode (lower dissipation current mode) from a normal operation mode after a passage of a predetermined time.

When the IC recorder enters the operation mode, checking is performed to see whether or not the switches are turned ON, in an order of the recording switch (REC), reproduction switch (PLAY), fast forward switch (FF), REW switch, stop switch (TOP), menu switch (MENU) and erase switch (ERASE), by the switch detecting operations shown in steps S3 to S9.

That is, when the turned ON switch is the record switch at step S3, control goes to step S10 and a subroutine “record processing” is executed. If, likewise, the turned ON switch is the reproduction switch at step S4, control goes to step S11 and a subroutine “reproduction processing” is executed. If the turned ON switch is the fast forward switch at step S5, control goes to step S13 and a subroutine “fast forward processing” is executed.

If the turned ON switch is the REW switch at step S6, control goes to step S12 and a subroutine “REW processing” is executed. If the turned ON switch is the stop switch at step S7, control goes to step S14 and a subroutine “STOP” is executed.

If the turned ON switch is the menu switch at step S8, control goes to step S15 and a subroutine “menu changing processing” is executed. If the turned ON switch is the erase switch at step S9, control goes to step S16 and a subroutine “erase processing” is executed.

After these subroutines are executed at these steps S10 to S16, control goes to step S17. At step S17, the timer started at step S2 is reset and a restart can be made and then control goes to step S3.

If all the switches are turned OFF at steps S3 to S9, the time counting of the timer restarted at step S2 is decided at step S18. If the counted time is within a predetermined time period, control goes to step S3 and again the switch detection operation is carried out. If the counted time exceeds a predetermined time, control goes to step S19 and the process enters the subroutine “standby mode”. If the standby mode is entered, a lower power consumption operation is involved.

Stated in more detail, the supply of the electric power to the image input section 48, voice input section 52, digital signal processing section (DSP) 54, image reproducing section 56, voice reproducing section 60, storage section 72 and display section 76 is interrupted or a non-select signal is output from the system control section 70 to a corresponding chip enable terminal of an IC, not shown, constituting each block, thus entering a lower power consumption state.

At this time, a CPU, not shown, in the system control section 70 allows the operation clock to be switched back to a low speed clock of a lowest dissipation current level so that a low dissipation current state is obtained. Or, the operation clock may be switched from a main clock (for example, 9.28 MHz) to a subclock (for example, 32.768 KHz) and the main clock be completely stopped until a subsequent switch input is detected.

Incidentally, the above-mentioned subroutines “fast speed processing”, “REW processing”, “stop processing”, “menu changing processing”, “erase processing” and “standby mode” are performed with the use of the conventional technical means and, since this has no direct connection to the contents of the present invention, a detailed explanation will be omitted for brevity's sake.

The prosecution of the subroutine “record processing” at step S10 in the flowchart of FIG. 3 will next be explained below with reference to the flowchart of FIG. 4 and FIGS. 2 and 5.

When the record processing operation is started, various kinds of information, such as a mike sensitivity level (high/low), recording mode (standard/long play), file number and voice data storage area opening address, are stored in an index information area at step S21.

Then, at step S22, a decision is made to check whether a release flag is set or not. If, here, it is decided that the release flag is set, control goes to step S23. If, on the other hand, it is decided that the release flag is not set, control goes to step S24.

At step S23, the state of the first release switch during recording is detected. If, here, the first release switch is in an OFF state, control goes to step S25 where the release flag is reset. Then, an ON state of the boosting circuit is stopped and control goes to step S32.

If the first release switch is turned ON at step S32, control goes to step S27 and the state of the second release switch is detected. If at step S27 the second release switch is turned ON, control goes to step S28 and an image capturing flag is set. After this, control goes to step S32. If at step S27 the second switch is turned OFF, processing at step S28 is skipped and control goes to step S32.

At step S24, the state of the first release switch during recording is detected and, when the first release switch is turned ON, that is, the first release switch is turned ON during the recording time, control goes to step 29 and the image pickup device (CCD) 46 starts to conduct. And at step S30 the voltage boosting circuit starts to conduct and at step S31 the release flag is set. After this, control goes back to step S32.

It is to be noted that the first and second release switches are equivalent to a later-described release switch (REL).

At step S32, the subroutine “image capturing processing” is executed as will be set out in more detail below.

At step S33, the voice signal is encoded by the digital signal processing section (DSP) 54. The encoding per se is performed in frame units and, at step S34, it is performed continuously until the voice data reaches a predetermined number of frames.

If the voice data stored in the buffer memory, not shown, in the system control section 70 reaches a predetermined number of frames, control goes to step S35. At step S35, the voice data is stored by being written in a sequential order from a voice data storage area starting address in the storage (memory) section 72.

Where the voice data which encodes, for example, a 10 bits/frame voice signal to 4 bits/frame one is written into the storage (memory) section 72 in 512 byte units, then the predetermined number of frames becomes 1024.

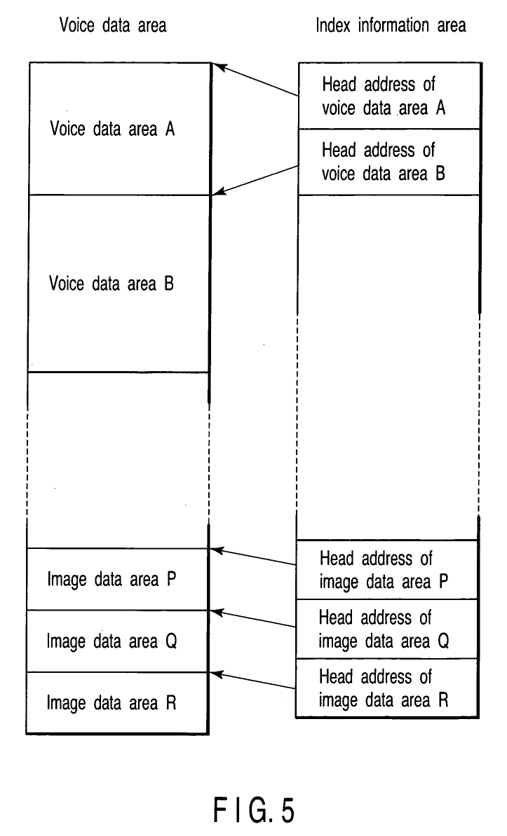

As shown in FIG. 5, the data is stored in the voice data area A and voice data area B sequentially, for example, from a head address of the voice data area. Further, the starting addresses corresponding to the voice data area A and voice data area B are stored in the index information area as the head address of the voice data area A and that of the voice data area B.

In this connection, it may be needless to say that, each time the voice data area C, voice data area D, . . . are sequentially secured, the corresponding head addresses of the respective voice data areas are stored in the index information area.

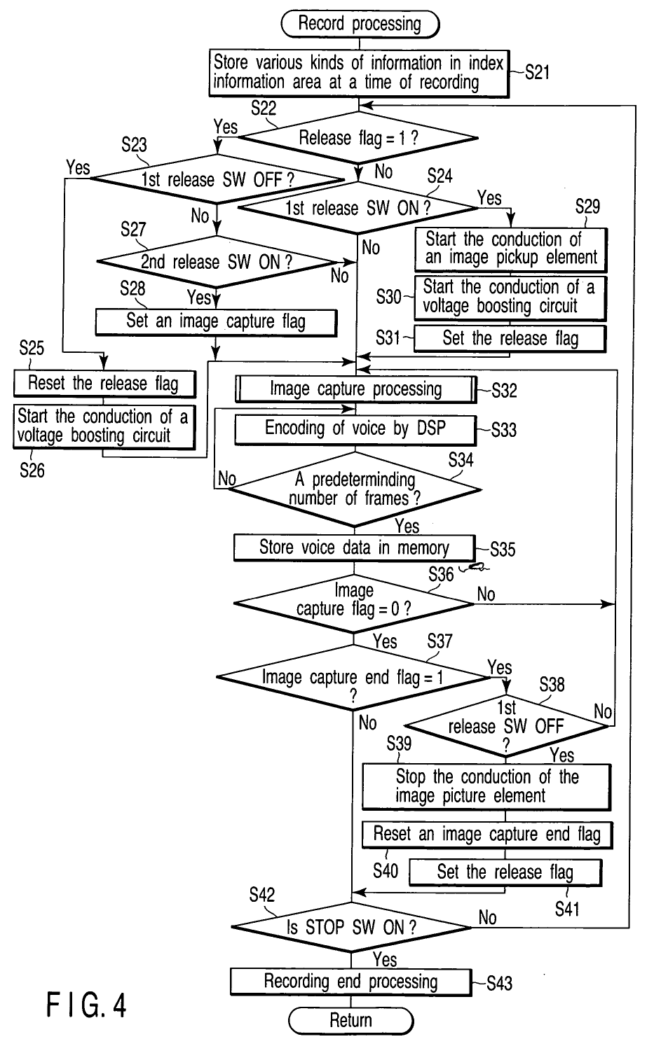

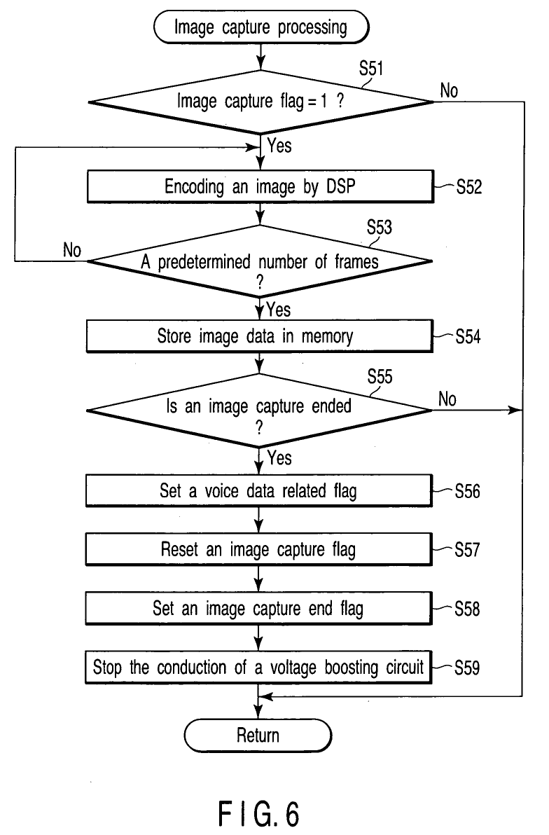

The operation of the subroutine “image capturing processing” at step S32 of the flowchart of FIG. 4 will next be explained below with reference to the flowchart of FIG. 6 and FIGS. 2 and 5.

If the subroutine “image capturing processing” is entered, checking is performed to check whether or not, at step S51, an image capturing flag is set. If the image capturing flag is not set, normal recording processing is executed. If, on the other hand, the image capturing flag is set, control goes to step S52 and the encoding of the image signal is performed by the digital signal processing section (DPS) 54.

The encoding per se is performed in frame units as in the case of the voice data. At step S53, the processing is performed continuously until the image data amounts to a predetermined number of frames. When, at step S53, the voice data stored in the buffer memory, not shown, in the system control section 70 equals a predetermined number of frames, control goes to step S54. At step S54, the voice data is stored by being written sequentially from the voice data storage area starting address of the storage (memory) section 72.

As shown in FIG. 4, the starting address of the image data area is stored sequentially, for example, from the last address of the image data area. Further, the starting addresses corresponding to the image data area P, image data area Q and image data area R are stored in the index information area as the head address of the image data area P, the head address of the image data area Q and the head address of the image data area R. As in the case of the above-mentioned voice data, the head addresses of the image data are stored in the index information area each time the image data area is secured.

The processing operations of steps S51 to S54 are repeated until the image capture is ended at step S55. After the ending of the image capture, a voice data-related flag is set at step S56 and then an image capture flag is reset at step S56. Further, an image capture ending flag is set at step S57 and the conduction of the voltage boosting circuit is stopped at step S58. After this, the process quits the main routine.

With respect to the voice data-related flag, an explanation will be made in more detail below in connection with a later-described image reproducing processing.

The record processing of the flowchart of FIG. 4 will be explained below in connection with step S36 et seq.

At step S36, it is decided whether or not the above-mentioned image capture flag is set. If the image capture flag is not set, control goes to step S32. If, on the other hand, the image capture flag is set, control goes to step S37 and the encoding of the voice signal (step S33) and encoding of the image signal (step S52) proceed by one DSP simultaneously. That is, in order not to cause any sound break during the pickup, the voice data and image data are alternately stored in the storage (memory) section 72 for each predetermined number of frames (steps S35 and S54).

After the image capture has been ended, at step S37, the encoding of the image signal proceeds while the image capture end flag is decided. During this time period, the state of the first release switch is detected at step S38. When the OFF of the first release switch is detected, control goes to step S39 and the conduction of the image pickup device 46 is stopped. At steps S40 and S41, the image capture end flag and release flag are reset. After this, control goes to step S42. If, on the other hand, the ON of the first release switch is detected, the process goes to step S32.

Until the stop switch (STOP) is turned ON at step S42, steps S22 to S41 repeat the processing operation in accordance with a predetermined release sequence. With the stop switch (STOP) ON, control goes to step S43 and the record end processing is performed and hence recording is stopped.

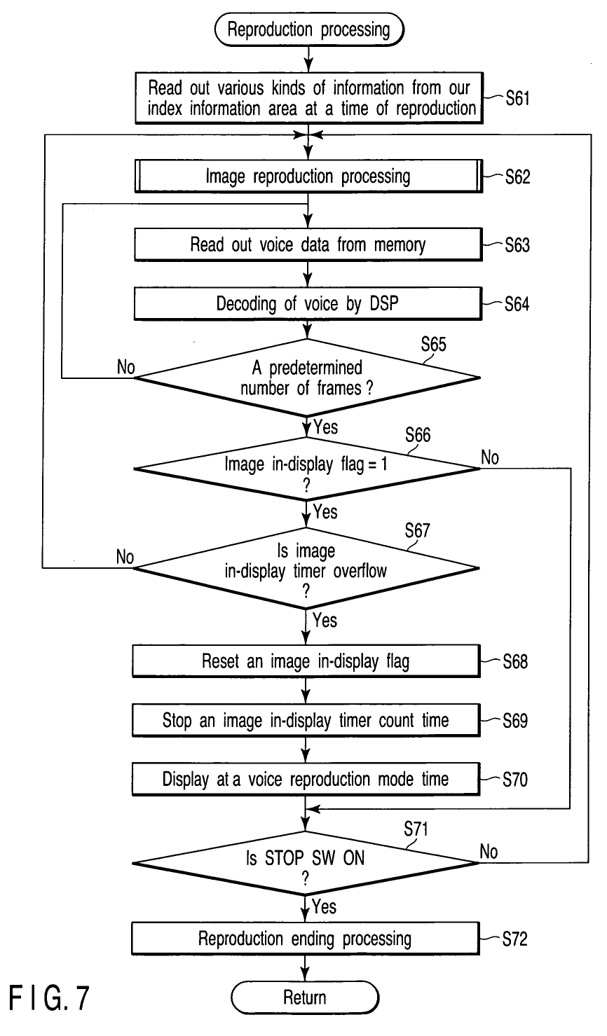

The operation of the subroutine “reproduction processing” at step S11 in the flowchart of FIG. 3 will be explained below with reference to the flowchart of FIG. 7 and FIG. 2.

Upon the start of the reproduction, various kinds of information such as a recording mode (standard/long play), file number and stored voice data storage area start address related to the selected voice data area are read out from the index information area at step S61. After the execution of the subroutine of the image reproduction processing at step S62, the voice data stored in the storage (memory) section 72 are read out sequentially from the voice data storage area starting address at step S63.

At step S64, the encoding operation is performed done by the digital signal processing section (DSP) 54. Since the encoding operation is performed in frame units, it is continuously performed until the voice data equals a predetermined number of frames at step S65. The voice data, while being sequentially stored in the buffer memory, not shown, in the system control section 70, is output as a voice signal to the voice reproducing section 60. If, on the other hand, the voice data does not reach the predetermined number of frames, control goes back to step S63.

When the encoding of the voice data is ended for the predetermined number of frames, control goes to step S66 and the state of an image in-display flag is decided. Here, if the in-display flag is set, the reproduction starting of the voice and image display on the display section 76 are simultaneously carried out. If, on the other hand, the image in-display flag is not set, control goes to step S71.

Since, upon the reproduction of any message, only several seconds are sufficient to recognize the speaker from the start of an image display, it is decided whether or not an image in-display timer starting a time count by later-described image reproduction processing exceeds a predetermined time at step S67. If NO, control goes to step S62 and the processing operations at step S62 to S67 are repeated. If YES, control goes to step S68 and the image in-display flag is reset.

At step S69, the counting of the image in-display timer is stopped and, at step S70, the display (recoding time, reproduction elapsed time, recording mode (standard/long), file number and so on) at a normal reproduction mode time is made at step S70. And at step S71, the state of the stop switch (STOP) is decided and, until the stop switch (STOP) is turned ON, the processing operations at step S62 to S71 are repeated. If the stop switch (STOP) is turned ON, the reproduction ending processing is performed at step S72 and the reproduction is ended.

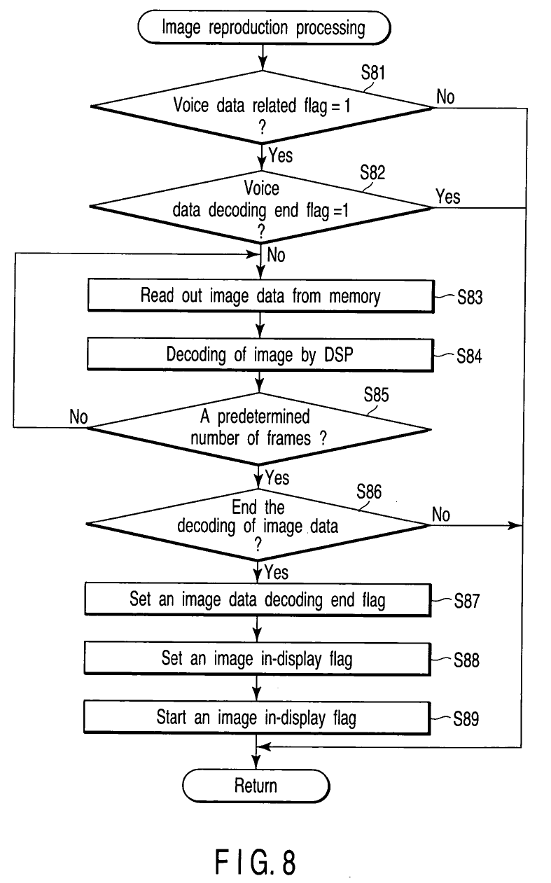

The operation of the subroutine “image reproduction processing” at step S62 in the flow chart of FIG. 7 will be explained below with reference to the flowchart of FIG. 8 and FIG. 2.

When the main routine is entered, detection is made to see whether or not, at step S81, a voice data related flag is set. If NO, the process quits the main routine and the normal reproduction processing for encoding the voice data only is carried out. If YES, control goes to step S82.

It is decided whether or not an image data decoding end flag is set at step S82. If YES, the process quits the main routine and, if NO, control goes to step S83. At step S83, the image data stored in the storage (memory) section 72 is read out sequentially from the image data memory area start address.

Then at step S84 the image data is encoded by the digital signal processing section (DSP) 54. Since the encoding of the image data is done in frame units as in the case of the voice data, the processing operations of steps S83 to S85 are continuously effected until the image data equals a predetermined number of frames. By doing so, the image data, while being sequentially stored in the buffer memory, not shown, in the system control section 70, is output as an image signal to the image reproducing section 56.

Steps S81 to S85 are repetitively effected until the encoding of the image data is ended at step S86. Simultaneously with the ending of the encoding of the image data, control goes to S87 and the image data encoding end flag is set. When the image in-display flag is set at step S88, the counting of the image in-display times is started at step S89. After this, the main routine is ended.

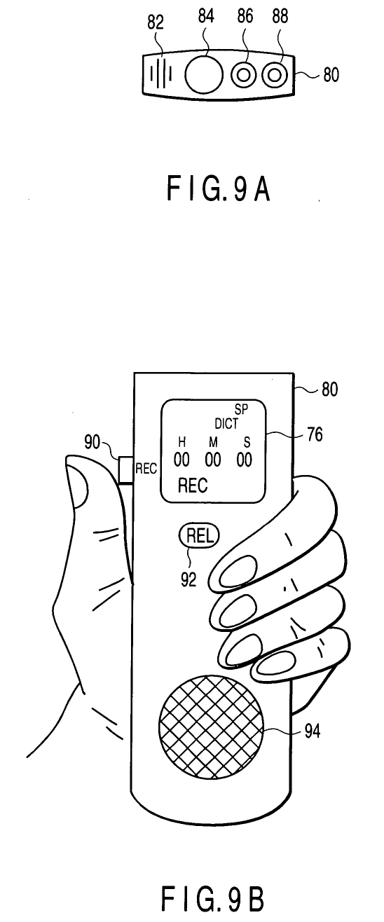

FIGS. 9A and 9B show an outer structure of the thus formed IC recorder, FIG. 9A being a top view and FIG. 9B being a front view showing the state of the operation display section at a time of recording.

At the top surface of the IC recorder 80 of the present embodiment are provided a microphone hole section 82, an image pickup lens 84, a MIC jack 86 and an earphone jack 88. Within the IC recorder 80, the microphone (MIC) 50 and image pickup device (CCD) shown in FIG. 2 are arranged in positions opposite to the microphone hole section 82 and image pickup device (CCD). The directivity of the microphone 50 is substantially the same as that of the image capture direction of the image pickup lens 24. Therefore, the operator can obtain an image smoothly, at a time of recording, without having any discomfort.

A display section 76 corresponding to the image display section 58 is provided at the front section of the IC recorder 80. A release switch (REL SW) 92 is provided at the lower position of the display section 76 and a recording switch (REC SW) 90 is provided near the display section 76 at the side portion of the IC recorder 80.

It is to be noted that the operation switches other than the recording switch (REC SW) 90 and release switch (REC SW) 92, though not shown in particular, are provided on the front surface side or sidesurface side of the IC recorder 80 in an easy-to-operate fashion.

A speaker hole section 94 is provided at the lower portion of the front surface of the IC recorder 80. Within the IC recorder 80, the speaker (SP) 62 shown in FIG. 2 is provided in a position corresponding to the speaker hole section 94.

Further, as the above-mentioned operation switches use is made of feather touching switches called, “normal tactile push switches”.

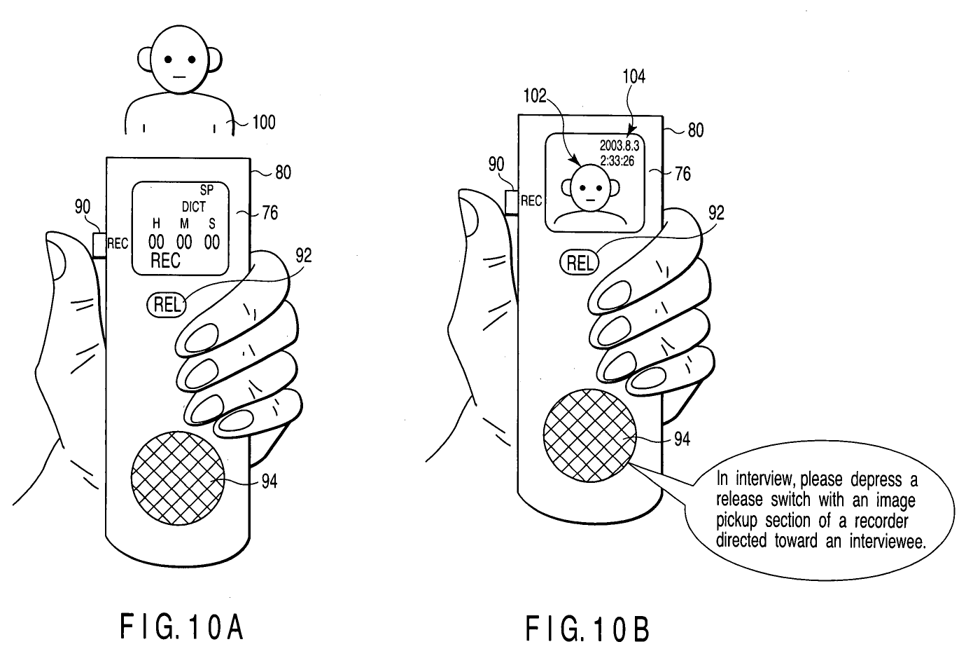

The message recording of the speaker and reproduction of voice/image on the thus structured IC recorder will be explained below with reference to FIGS. 10A and 10B.

The recording operation of the IC recorder 80 will be explained below with reference to FIG. 10A.

With the recording switch 90 of the IC recorder 80 ON, recording is started. At this time, an initial display of the recording start appears on the display section 76, thus informing the operator of a recording operation state. In this state, as shown in FIG. 10A, the release switch (REL) 92 is turned ON with the upper surface of the IC recorder 80 directed toward the speaker 100 and, by doing so, it is possible to capture his or her image.

The capture of an image is effected each time the release switch (REL) 92 is turned ON. Even in an interview, etc., held with a plurality of interviewees, it is possible to positively record an image of each interviewer and his or her matching messages.

In order to positively record an image, an image captured by the image pickup lens 84 may be displayed on the display section 76, as shown in FIG. 10B, for a brief time period following the ON of the release switch (REL) 92. And after the framing of the subject has been decided, an image may be captured by turning the release switch (REL) 82 ON again.

The reproduction of an image at the time of reproduction on the IC recorder will be explained below with respect to FIG. 10.

When a reproduction switch, not shown, on the front surface side or sidesurface side of the IC recorder 80 is turned ON, reproduction is started. At this time, a massage as shown, for example, by a balloon in FIG. 10B is produced from the speaker 94 and an image of the speaker related to his or her massage is displayed on the display section 76. In this case, date information 104 such as the time of day of recording, together with the image 102 of the speaker, may be displayed on the display section 76.

The image may be displayed until the reproduction of the message related to the image is ended. Of course it may be displayed for only a predetermined time interval from the start of the reproduction as set out above.

If the recognition of the image is not necessary, it may not be displayed. When, for example, no image related to the message is recorded, a normal display is made, at a time of reproduction, such as a recording time, reproduction elapsed time, recording mode (standard/long) and file number.

According to the first embodiment, the speaker can be visually recognized, will prove very useful effective, in an interview, etc., where the interviews of a plurality of interviewees need to be documented and matched with their images at a later time.

An explanation will be made below about a second embodiment of the present invention.

Since, in the second embodiment, the structure of the IC recorder is basically the same as that of the first embodiment and the same as in FIGS. 1, 2, 9A, 9B, 10A and 10B, the same reference numerals are employed in this embodiment to designate parts or sections corresponding to those shown in the first embodiment and any further explanation and illustration are omitted for brevity's sake except for the different portions, which will be set out below.

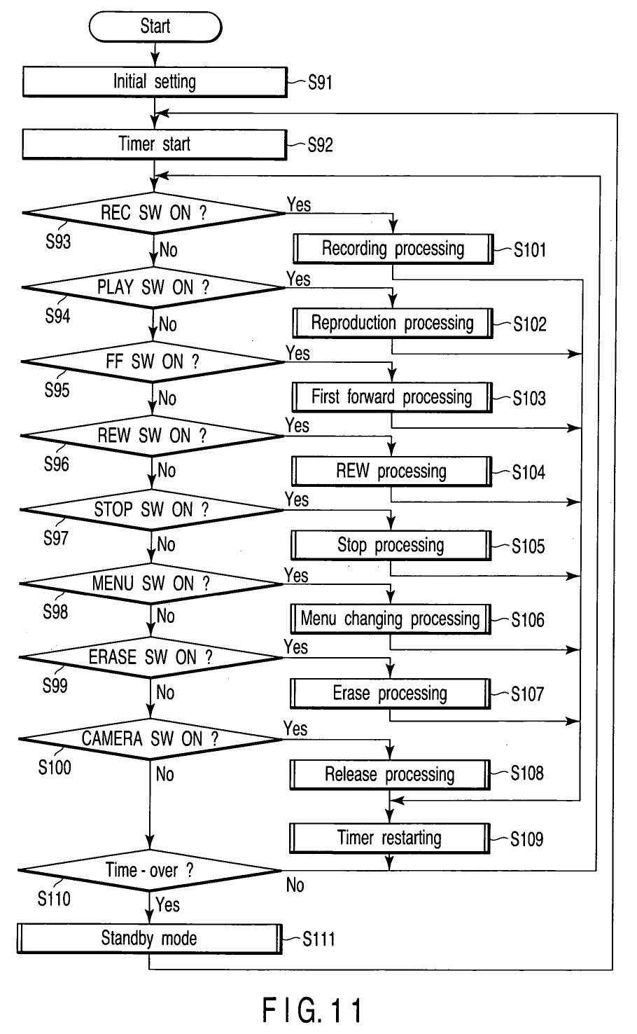

FIGS. 11 is a flowchart for explaining the main operation of the IC recorder according to the second embodiment of the present invention.

In this main flowchart, the steps other than the decision of a camera switch (CAMERA) ON at step S100 and subroutine “release processing” at step S108 are the same as those of the flowchart of FIG. 3 in the first embodiment. Therefore, the processing operations at steps S91 to S99, S101 to S107, S109 and S110 to S111 refer to steps S1 to S9, S10 to S15, S17 and S18 to S19 and any further explanation of these is omitted.

If, at step S100, the turned ON switch is a camera switch (CAMERA), control goes to step S108 and a subroutine “release processing” is performed and, after this control goes to step S109 where a timer is restarted. After this, control goes back to the main routine.

As the camera switch use may be made of a mechanical switch, such as a slide switch, which can force-hold its state.

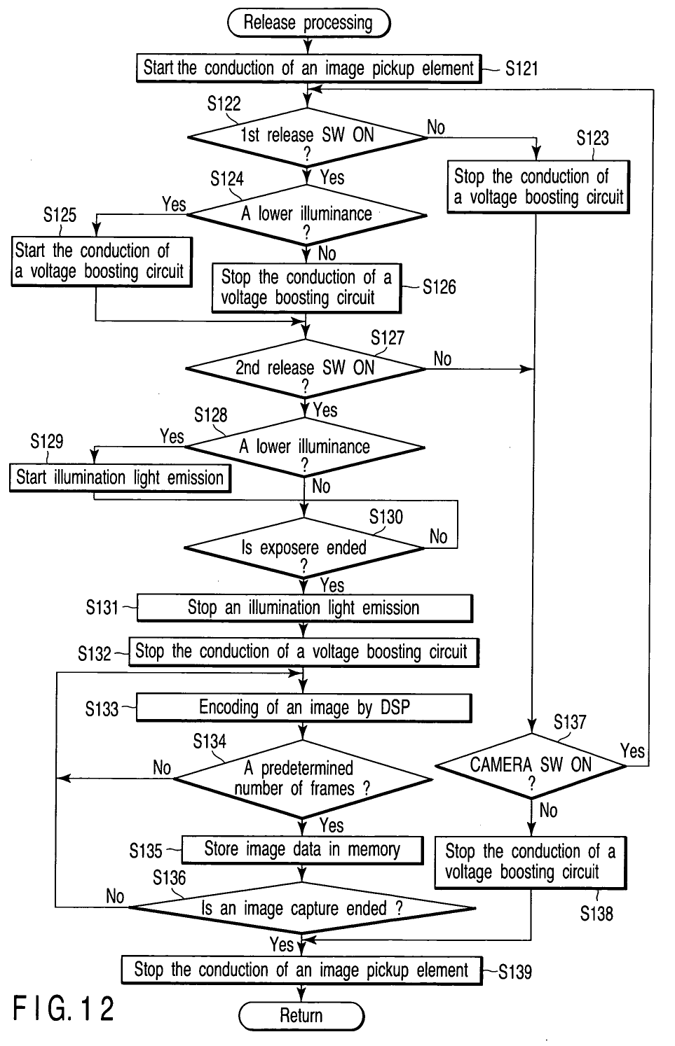

The operation of the subroutine “release processing” at step S108 in the flowchart of FIG. 11 will next be explained below with reference to step S108 in FIG. 12 and FIG. 2.

If the process enters a camera function mode, the conduction of the image pickup device (CCD) is started at step S121. Then at step S122 the first release switch is detected as being an ON or OFF state. If, here, the first release switch is not turned ON, control goes to step S123 and the conduction of a voltage boosting circuit is stopped. If the first release switch is turned ON, control goes to step S124.

At step S124 the luminance of a subject or illuminance under an image taking circumstance, while being measured, is decided. If the luminance or illuminance is a lower illuminance not satisfying a predetermined exposure light value, control goes to step S125 where the conduction of the voltage boosting circuit is started. As shown in the flowchart of FIG. 4, the measuring/decision (step S124) is not effected and the conduction of the voltage boosting circuit may be made each time the first release switch is turned ON. It is needless to say that the use of the voltage boosting circuit only at the lower illuminance time can be more efficient in terms of energy efficiency.

If no lower illuminance is involved at step S124, control goes to step S126 where the conduction of the voltage boosting circuit is stopped.

And at step S127, checking is made to see whether or not the second release switch is turned ON. If YES, control goes to step S128 and, if NO, control goes to step S137.

At step S137, the state of the camera switch is detected. If, here, the camera switch is turned ON, control goes back to step S122 and the sequential processing operation is repeated. If, on the other hand, the camera switch is turned OFF, step S138 goes to step S138 and the conduction of the voltage boosting circuit is stopped. After this, control goes to step S139.

At step S128, just pre-exposure subject luminance or illuminance under the image capture circumstance, while being measured, is decided. If the lower illuminance is involved, control goes to step S129 and illumination light by the light emitting section 78 is started almost in synchronization with the starting of the exposure. Or, a flashing illuminance light may be used from the start to the end of the exposure. In this connection it is to be noted that, if no lower illuminance is involved at step S128, control skips step S129.

At step S130, it is decided whether or not the exposure is ended. Here, when the exposure is ended, control goes to step S131 and illumination light is stopped. Then, at step S132, the conduction of the voltage boosting circuit is stopped. At step S133, the encoding of the image signal is started by the digital signal processing section (DSP) 54. The encoding is effected in frame units and it is continuously performed at step S134 until the image data reaches a predetermined number of frames.

At step S134, if the image data stored in the buffer memory, not shown, in the system control section 70 reaches a predetermined number of frames, control goes to step S135. At step S135, the image data is stored by being written sequentially from the image data storage area start address. Since the sequential image data writing processing is the same as that explained in connection with FIG. 5, the explanation of it is omitted here.

The processing operations of steps S133 to S135 are repetitively performed until the image capture is ended at step S136. After the ending of the image capture, control goes to step S139 and the conduction of the image pickup device (CCD) 46 is stopped and thus the release processing is ended.

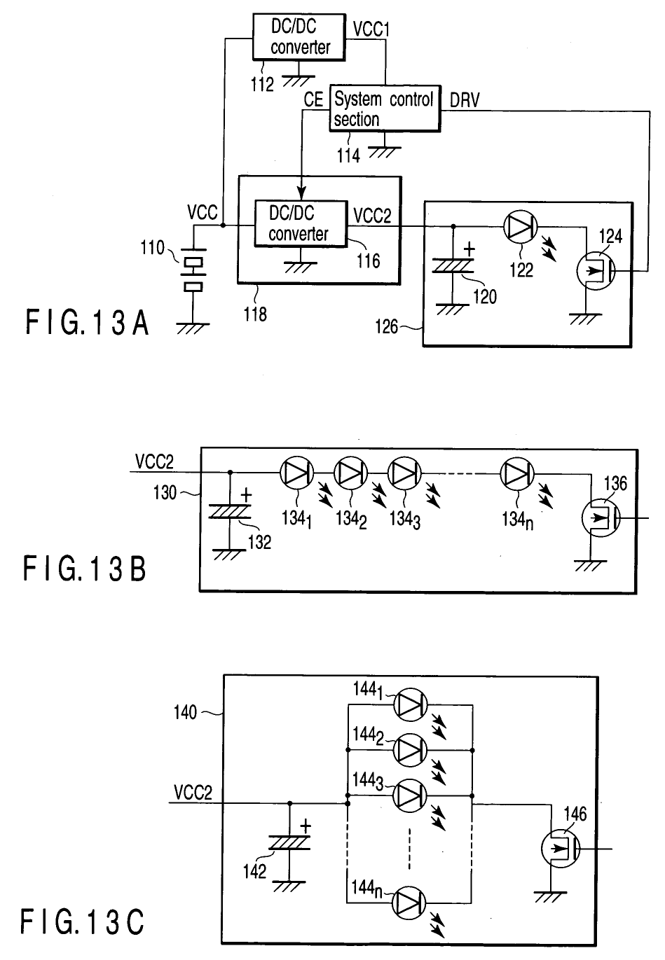

Next, the voltage boosting and light emitting operation of the second embodiment will be explained below with reference to FIGS. 13A to 13C.

FIGS. 13A to 13C are schematic circuit arrangements for performing voltage boosting and light emitting operations of the second embodiment.

In FIGS. 13A, a DC/DC converter 112 connected to a battery 110, after boosting a battery voltage VCC to a predetermined voltage VCC1, supplies it to a system control section 114. On the other hand, a DC/DC converter 116 performs a voltage boosting operation only when a chip enable signal CE of the system control section 114 is active and a capacitor 120 in the light emitting circuit (1) 126 is charged to a predetermined voltage VCC2.

A voltage boosting circuit 118 comprised of the DC/DC converter 116 may be, for example, of a self-excited type using a blocking oscillation or of a separately exited type if the system control section 114 has a built-in PWN circuit.

A superhigh luminance LED 122 for illumination which is present in the light emitting circuit (1) 126 is driven by a pulse forward current and pulse width defined by an absolute maximal rating so as to obtain a maximal light emitting amount. This is, since a distant subject can be brightly and efficiently illuminated, it is suitable for exposure of a still image which may involve a “blur” problem when it is captured. Of course, if a subject is in a near distance, it may be captured in a moving image-like way while observing its state under a continuously lit condition. In this case, however, the light emitting amount involved is extremely lowered when compared with the above-mentioned pulse driving.

The value of the output voltage VCC2 of the DC/DC converter 116 connected to the anode terminal of the super-high luminance LED 122 for illumination is made adequately larger than the forward voltage of the super-high illumination LED 122. For example, if the forward voltage of the super-high illuminance LED 122 for illumination is 3 to 4V, at least the value of the output voltage VCC2 is set to 5 to 6V and is made constant in level so as not to cause any voltage drop by a large current at a pulse driving time. Or it may be made constant in level within the pulse forward current value. Further, the output voltage VCC2 of the DC/DC converter 116 is made variable and the light emitting amount of the super-high luminance LED 122 may be made adjustable.

The charge of the capacitor 120 at a time of charging which is connected to the anode terminal of the super-high luminance LED 122 compensates for a momentary rush current mainly at a time of driving a pulse, thus alleviating a voltage drop at a transient response time caused by any overload of the DC/DC converter 116. A power FET 124 is connected to the cathode terminal of the super-high luminance LED 122 and configured to be turned ON and OFF by a drive signal DRV which is output from the system control section 114 at a time of illuminating the subject.

A light emitting circuit (2) 130 as shown in FIG. 13B is one practical form for achieving a light amount increase by series-connecting the super-high luminance LED 134₁, 134₂, 134₃, . . . , 134ₙ so as to more brightly illuminate a distant subject. In the case of a series-connected array, the value of the output voltage VCC2 of the DC/DC converter 16 is made adequately larger than the sum of the forward voltages of the super-high luminance LED's 134₁, 134₂, 134₃, . . . , 134ₙ for illumination. The pulse forward current and pulse width may be set under the same condition as when the super-high luminance LED for illumination is driven as a single unit. Further, the capacitance of the capacitor 132 connected to the mode terminal and the rating of a power FET 136 connected to the cathode terminal may be set under the same condition as in the case of a single unit.

Incidentally, the light emitting amount is proportional to the number of the super-high LED's for illumination and, if the driving capability of the battery 110 and that of the voltage boosting circuit 118 have an adequate allowance, super-high luminance LED's 144₁, 144₂, 144₃, . . . , 144ₙ for illumination can be driven in a parallel-connection array as in the case of a light emitting circuit (3) 140 shown in FIG. 13C. In this case, the value of the output voltage VCC2 of the DC/DC converter 116 may be set under the same condition as when the super-high luminance LED for illumination is driven as a single unit. However, since the forward current is increased proportionally to the number of such LED's, the capacitance of a capacitor 142 connected to the anode terminal as well as the rating of a power FET 146 connected to the cathode terminal has to be made higher than when the LED is driven as a single unit.

It is needless to say that the light emitting circuits have only to be selectively adopted in accordance with the use to which the system is put. In the way, the light emitting color of the super-high luminance LED for illumination may be a white color which is excellent in color tone reproduction of a subject as set out above.

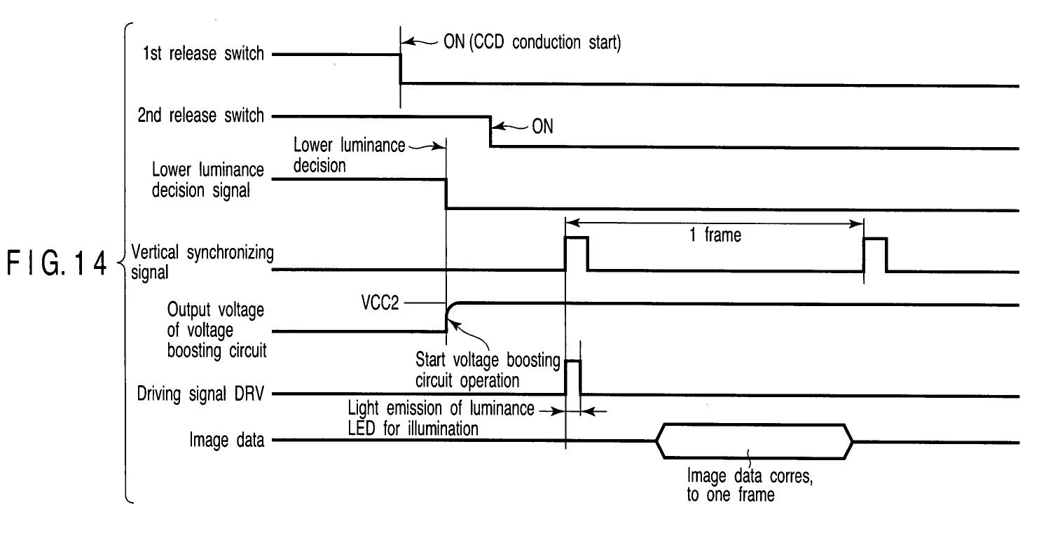

The operation of the light emitting timing of the second embodiment will be explained below with reference to a timing chart of FIG. 14.

When a first release switch is turned ON, the conduction of the image pickup device (CCD) 46 is started and the subject luminance or illuminance under an image capturing circumstance, while being measured, is decided. If the subject luminance or illuminance under an image capturing circumstance is at a lower level not satisfying a predetermined exposure value (detection of a variation H→L of the lower luminance deciding signal in FIG. 14), the operation of the voltage boosting circuit 118 shown in FIG. 13A is started and the VCC2 voltage is generated.

When a second release switch is turned ON, exposure is started and a vertical synchronizing signal is output from the image pickup device (CCD) 46. In the system control section 114 shown in FIG. 13A, a drive signal DRV is output substantially in synchronism with the vertical synchronizing signal and the light emission of the super-high luminance LED is performed for a predetermined time to provide correct exposure. After the exposure, the image data, while a vertical synchronizing signal corresponding to one frame is output, is written in the above-mentioned storage (memory) section 72.

Also in the second embodiment, it is possible to easily recognize a speaker and his or her messages at a time of reproduction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An image pickup device comprising:
a light emitting element configured to illuminate a subject;
a voltage boosting circuit configured to boost a power supply voltage to a voltage value necessary for the light emitting element to emit light and to supply electric power to the light emitting element;
light emitting control means configured to control the light emission of the light emitting element by controlling the electric power supplied from the voltage boosting circuit to the light emitting element; and
voltage boosting control means configured to, in response to the operation of a predetermined operation switch, start the boosting of a power supply voltage by the voltage boosting circuit.

2. An image pickup device according to claim 1, wherein the predetermined operation switch is comprised of a release switch for designating an image pickup.

3. An image pickup device according to claim 1, wherein the predetermined operation switch is comprised of a two-step pressing switch and the voltage boosting control means is configured to control the voltage boosting circuit so as to start the boosting voltage through a one-step pressing operation of the predetermined operation switch.

4. An image pickup device according to claim 1, wherein the voltage-boosting control means is configured to control the voltage boosting circuit so as to stop the boosting voltage in response to the ending of the predetermined operation switch.

5. An image pickup device according to claim 3, wherein the voltage boosting control means is configured to control the voltage boosting circuit so as to stop the boosting of the voltage in response to the releasing of the one-step pressing operation of the predetermined operation switch.

6. An image pickup device according to claim 1, further comprising an image pickup element and exposure amount detecting means configured to detect whether or not a light exposure amount of the subject reaches a predetermined value, said light emitting control means controlling the light emitting element so as to, when the light emission of the light emitting element is started in synchronization with a vertical synchronizing signal of the image pickup element and said light amount detecting means detects that said predetermined value has been reached, stop the light emission of the light emitting element.

7. An image pickup device according to claim 1, wherein said light emitting element is comprised of a semiconductor light emitting element.

8. An image pickup device comprising:
image pickup means configured to pick up image data of a subject during the recording of voice data;
storage means configured to store the voice data and the image data related to the voice data;
a light emitting element configured to illuminate the subject;
a voltage boosting circuit configured to boost a power supply voltage up to a voltage value necessary to the light emission of the light emitting element and to supply electric power to the light emitting element;
light emitting control means configured to control the light emission of the light emitting element by controlling electric power from the voltage boosting circuit to the light emitting element; and
voltage control means configured to, in response to the operation of a predetermined operation switch, start the boosting of the power supply voltage by the voltage boosting circuit.
